(19) United States
(12) Patent Application Publication
(10) Pub. No.: US 2022/0324759 A1
(43) Pub. Date: Oct. 13, 2022

(54) MANUFACTURING METHOD OF SINTERED BODY AND MANUFACTURING APPARATUS OF SINTERED BODY

(71) Applicant: NATIONAL UNIVERSITY CORPORATION TOKAI NATIONAL HIGHER EDUCATION AND RESEARCH SYSTEM, Aichi (JP)

(72) Inventors: Takahisa YAMAMOTO, Aichi (JP); Tomoharu TOKUNAGA, Aichi (JP); Yudai YAMASHITA, Aichi (JP); Tsuyoshi KURACHI, Aichi (JP); Kimihiro TAGUCHI, Aichi (JP); Seiya TAKAHASHI, Aichi (JP); Ryosuke UMEMURA, Aichi (JP)

(21) Appl. No.: 17/631,363

(22) PCT Filed: Jul. 29, 2020
(86) PCT No.: PCT/JP2020/028994

§ 371 Date: Jan. 28, 2022

(30) Foreign Application Priority Data
Jul. 29, 2019 (JP) 2019-138645
Aug. 2, 2019 (JP) 2019-142722
Dec. 26, 2019 (JP) 2019-236358

(51) Int. Cl. C04B 35/64; C04B 35/48; H05B 3/00; H05B 1/02; F27D 11/04

(52) U.S. Cl. CPC C04B 35/64; C04B 35/48; H05B 3/0004; H05B 1/023; F27D 11/04; C04B 2235/3246; C04B 2235/666; C04B 2235/661; C04B 2235/656; C04B 2235/94

(57) ABSTRACT

A manufacturing method of a sintered body is a manufacturing method of the sintered body which increases a temperature while applying an electric field to a ceramic compact. This method controls a current which flows to the ceramic compact so that a sintering rate becomes constant.

### CROSS-REFERENCE TO RELATED APPLICATIONS

The present application is based on Japanese Patent Application No. 2019-138645 filed on Jul. 29, 2019, Japanese Patent Application No. 2019-142722 filed on Aug. 2, 2019, and Japanese Patent Application No. 2019-236358 filed on Dec. 26, 2019 and claims benefit of priorities thereof, and all the contents of these patent applications are incorporated herein by reference.

### TECHNICAL FIELD

The present disclosure relates to a sintered body.

### BACKGROUND ART

Generally, a ceramic sintered body is prepared by compacting/molding raw powder and subjecting the molded body to thermal treatment under high temperature. A thermal treatment temperature (this is called a sintering temperature) depends on the type of the ceramic, but is 1200° C. to 1500° C., and sintering time is about several hours. In order to improve the density of a sintered body, other than the general sintering method as described above, various methods such as a method in which a pressure is applied from outside (hot pressing method, HIP method, etc.) have been invented.

Recently, a flash sintering method which can finish sintering at a lower temperature and in a shorter period of time than conventional methods by applying an electric field to a ceramic compact has been developed (see Non Patent Literature 1). A characteristic of this sintering method is that, when the temperature of a ceramic compact is increased while an electric field is applied thereto, a sample current rapidly increases at a certain temperature (hereinafter, this phenomenon may be referred to as “flash phenomenon”), and the sintering process instantly finishes. Also, it has been found out that, when an electric field intensity is increased, the temperature at which shrinkage of a sintered body starts is lowered, and the behavior of shrinkage more rapidly changes.

### CITATION LIST

### Non Patent Literature

[Non Patent Literature 1] Marco Cologna et al, “Flash Sintering of Nanograin Zirconia in <5 s at 850° C.”, Rapid Communications of the American Ceramic Society, 2010, Vol. 93, No. 11, p. 3556-3559

### SUMMARY OF INVENTION

### Technical Problem

However, a flash temperature at which the flash phenomenon occurs is unambiguously determined if the electric field is constant. On the other hand, in order to further increase the final density of the sintered body, a higher flash temperature is conceived to be advantageous. However, the flash temperature cannot be arbitrarily controlled by conventional flash sintering methods. Also, if the amount of electric power applied to a sample is too large, metal electrodes which are in contact with the sample melt in some cases. Therefore, the amount of electric power which can be applied to a ceramic compact in a sintering process is limited. Therefore, there is room for further improvement from a viewpoint of the density (densification) of the sintered body.

The present disclosure has been accomplished in view of such circumstances, and it is one of exemplary objects thereof to provide a new technique which improves the density of a sintered body.

### Solution to Problem

In order to solve the above described problems, a manufacturing method of a sintered body of a certain aspect of the present invention is a manufacturing method of a sintered body which increases temperature while applying an electric field to a ceramic compact, wherein a current which flows to the ceramic compact is controlled so that a sintering rate becomes constant.

### Advantageous Effects of Invention

According to the present disclosure, a sintered body having a high density, which is difficult to be realized only by the conventional flash sintering method, can be provided.

### BRIEF DESCRIPTION OF DRAWINGS

FIG. 1 is a diagram illustrating changes in linear shrinkage percentage in processes of manufacturing sintered bodies from samples.

FIG. 2 is a diagram illustrating changes in sample currents caused by a conventional flash sintering method and Rate Control Flash.

FIG. 3 is a diagram illustrating changes in relative density in a case in which Ramping Flash is applied to high-speed sintering.

FIG. 4 is a diagram illustrating behaviors of sample currents of ICEFAST and a general flash sintering method.

FIG. 5 is a diagram illustrating changes in relative density in processes of manufacturing sintered bodies from samples.

FIG. 6 is a diagram illustrating a rough configuration of a manufacturing apparatus of a sintered body according to an embodiment.

FIG. 7(a) is a diagram illustrating a scanning electron micrograph of a center portion of a sintered body manufactured by the flash sintering method, and FIG. 7(b) is a diagram illustrating a scanning electron micrograph of an outer peripheral portion of the sintered body manufactured by the flash sintering method.

FIG. 8(a) is a diagram illustrating a scanning electron micrograph of a center portion of a sintered body manufactured by Rate Control Flash, and FIG. 8(b) is a diagram illustrating a scanning electron micrograph of an outer peripheral portion of the sintered body manufactured by Rate Control Flash.

FIG. 9 is a diagram illustrating a transmission electron micrograph of a sintered body manufactured by Rate Control Flash and results of composition analysis of yttrium in a predetermined region.

FIG. 10(a) is the transmission electron micrograph illustrated in FIG. 9, FIG. 10(b) is a diagram illustrating mapping of the element of zirconium by Energy Dispersive X-ray Spectroscopy (EDS) in the region illustrated in FIG. 10(a), and FIG. 10(c) is a diagram illustrating mapping of the element of yttrium by EDS in the region illustrated in FIG. 10(a).

FIG. 11 is a graph illustrating a relation (line L12) between the linear shrinkage percentage of a sample, which has been manufactured by the flash sintering method after calcination of a manufacturing method according to a third embodiment, and a furnace temperature.

FIG. 12 is a schematic diagram for describing the rearrangement of particles and inhomogeneous neck formation in the stage of calcination.

FIG. 13 is a graph illustrating changes in linear shrinkage percentage in a manufacturing method according to a fourth embodiment.

FIG. 14 is a graph illustrating changes in a sample current in the manufacturing method according to the fourth embodiment.

FIG. 15 is a diagram illustrating changes in linear shrinkage percentage in processes of manufacturing sintered bodies from samples according to a fifth embodiment.

FIG. 16 is a diagram illustrating changes in sample currents caused by a conventional flash sintering method and Rate Control Flash.

FIG. 17 is a perspective view illustrating outlines of a cuboidal ceramic compact provided between a pair of electrodes.

FIG. 18 is a diagram illustrating changes in relative densities in the cases in which a direct-current electric field and an alternating-current electric field having the same size of electric field are applied in the flash sintering method.

FIG. 19 is a diagram illustrating changes in relative densities in the cases in which the frequency of the alternating-current electric field was changed while using the same electric field and the same limit current value.

FIG. 20 is a diagram illustrating changes in relative densities in the cases in which alternating-current electric fields having different frequencies and limit current values are applied.

FIG. 21 is a diagram illustrating changes in relative densities in the cases in which direct-current electric fields are applied to ceramic compact samples having different cross sectional areas.

FIG. 22 is a diagram illustrating changes in relative densities in the cases in which alternating-current electric fields are applied to ceramic compact samples having different cross sectional areas.

FIG. 23 is a diagram for qualitatively describing the relation between electric fields and sample currents in a flash phenomenon.

FIG. 24 is a diagram illustrating an example of waveforms of voltages and currents of alternating-current control in a manufacturing method of a sintered body according to a sixth embodiment.

### DESCRIPTION OF EMBODIMENTS

A manufacturing method of a sintered body of a certain aspect of the present disclosure is a manufacturing method of the sintered body which increases a temperature while applying an electric field to a ceramic compact. This method controls a current which flows to the ceramic compact so that a sintering rate becomes constant.

According to this aspect, the sintered body which has a high density, which is difficult to be realized only by the conventional flash sintering method, can be manufactured in a comparatively short period of time. Note that the sintering rate is only required to be constant at least in the predetermined period of time after the current flowing to the ceramic compact has achieved a predetermined current value. In other words, the sintering rate is not required to be constant in all the time in the period in which the temperature is increased while the electric field is applied to the ceramic compact.

Another aspect of the present disclosure is also a manufacturing method of a sintered body. This method is a manufacturing method of a sintered body of increasing a temperature while applying an electric field to a ceramic compact, wherein a current flowing to the ceramic compact is controlled by a current profile determined so as to manufacture a ceramic sintered body having a density larger than a predetermined value.

According to this aspect, the sintered body which has a high density, which is difficult to be realized only by the conventional flash sintering method, can be manufactured in a comparatively short period of time.

A further another aspect of the present disclosure is also a manufacturing method of a sintered body. This method includes: a first process of, in a case that temperature increase is carried out while an electric field is applied to a ceramic compact, carrying out the temperature increase while applying a first electric field to the ceramic compact up to a flash sintering temperature at which a current flowing to the ceramic compact rapidly increases; and a second process of carrying out temperature increase while applying a second electric field smaller than the first electric field after the current flowing to the ceramic compact has rapidly increased and achieved a predetermined current value.

According to this aspect, the sintered body which has a high density, which is difficult to be realized only by the conventional flash sintering method, can be manufactured in a comparatively short period of time.

Raw powder of the ceramic compact may contain zirconium oxide as a main component.

A further another aspect of the present disclosure is a manufacturing apparatus of a sintered body. This apparatus is provided with: a heater that heats a ceramic compact; an electrode for applying a voltage to the ceramic compact; a voltage applier that applies the voltage to the electrode so that a predetermined current flows to the ceramic compact; a storage that stores a current profile determined so as to manufacture a ceramic sintered body having a density higher than a predetermined value; a controller that controls the voltage applier on the basis of the current profile while subjecting the ceramic compact to temperature increase by the heater.

According to this aspect, by storing the current profile, which has been calculated in advance from experiments and calculations, in the storage in this manner, the ceramic sintered body having a higher density than a predetermined value can be manufactured without carrying out feedback control. Therefore, the necessity of a detection device or an arithmetic device for finding out the sintering rate for feedback control is eliminated, and the apparatus can be simplified.

A manufacturing method of a sintered body of further another aspect of the present disclosure is a manufacturing method of a sintered body of increasing a temperature while applying an alternating-current electric field to a ceramic compact having a predetermined shape provided between a pair of electrodes, and the method includes a first process of increasing the temperature while applying a first alternating-current electric field to the ceramic compact up to a flash sintering temperature at which a current flowing to the ceramic compact rapidly increases; and a second process of increasing the temperature while applying a second alternating-current electric field smaller than the first alternating-current electric field after the current flowing to the ceramic compact rapidly increases and achieves a predetermined current value.

According to this aspect, the sintered body which has a high density, which is difficult to be realized only by the conventional flash sintering method, can be manufactured with comparatively low electric power.

The application of the first alternating-current electric field may be executed in a voltage control mode in the first process, and the application of the second alternating-current electric field may be executed in a current control mode in the second process. As a result, after the flash phenomenon occurs, current control can be carried out so that the current value does not exceed the predetermined current value. Therefore, occurrence of melting of the electrodes caused by application of excessive electric power to the sample can be reduced. Note that the second process may be executed in an electric power control mode so that the application of the second alternating-current electric field does not exceed a predetermined electric power value.

When a fact that the current flowing to the ceramic compact has achieved the predetermined current value is detected, a transition from the voltage control mode to the current control mode may be carried out so that the current does not exceed the predetermined current value.

The first alternating-current electric field and the second alternating-current electric field may have a frequency of 10 Hz or higher. By virtue of this, the density of the sintered body can be further improved.

In addition to a shape which can be easily sintered, it is important that the ceramic compact has a practical shape after sintering. Therefore, the predetermined shape of the ceramic compact may be a cuboid or a columnar shape.

Raw powder of the ceramic compact may contain zirconium oxide as a main component.

A further another aspect of the present disclosure is a manufacturing apparatus of a sintered body. This apparatus is provided with the heater which heats a ceramic compact having a predetermined shape; a pair of electrodes for applying a voltage to the ceramic compact; a voltage applier which applies a voltage to the pair of electrodes; and a controller which control the voltage applier while increasing the temperature of the ceramic compact by the heater. The controller subjects the voltage applier to voltage control until the current flowing to the ceramic compact rapidly increases and, after the current flowing to the ceramic compact rapidly increases and achieves a predetermined current value, subjects the voltage applier to current control.

According to this aspect, even with comparatively low electric power which does not melt the electrodes, the sintered body having a high density which is difficult to be realized only by the conventional flash sintering method can be manufactured.

The controller may have a detector which detects the current flowing to the ceramic compact. When a predetermined current value is detected by the detector, the controller may carry out a transition of a voltage control mode of the voltage applier to a current control mode so that the current does not exceed the predetermined current value.

Note that arbitrary combinations of above constituent elements and expressions of the present disclosure converted among methods, devices, systems, etc. are also effective as aspects of the present embodiments.

Hereinafter, embodiments for carrying out the present disclosure will be described in detail with reference to drawings, etc. Note that, in the descriptions of the drawings, the same elements are denoted by the same reference signs, and redundant descriptions will be arbitrarily omitted. Also, the configurations described below are examples and do not limit the scope of the present disclosure at all.

A manufacturing method of a sintered body of the present disclosure is a technique which enables manufacturing in a temperature range lower than a temperature range used in a general sintering method and can significantly shorten manufacturing time. Following points are particularly focused on.
Increase in the actual temperature of a ceramic compact caused by Joule heat applied in a flash phenomenon largely contributes to the densification obtained in flash sintering at a lower temperature and in a shorter period of time.
When an applied electric field increases, a flash temperature changes to a low temperature side. The larger the electric field, the higher the Joule heat amount which can be applied in the flash phenomenon. However, on the other hand, the flash temperature is lowered, and the heating effect from an electric furnace is therefore lowered.

The inventors of the present application focused on these facts, diligently carried out studies to realize a sintered body having a high density, which has been difficult to be realized only by the conventional flash sintering method, and conceived of some novel manufacturing methods of sintered bodies.

### First Embodiment

A manufacturing method of a sintered body according to a first embodiment is a technique which carries out flash sintering while controlling a limit current amount and causing a sintering rate to be constant. This technique is a technique which improves a final achieved density by adjusting a densification rate of a compact to a constant rate while controlling rapid increase of a sample current, which occurs in flash sintering. When the manufacturing method of the sintered body according to the present embodiment is used, inhomogeneity of a densification state and a structure caused by an excessively rapid densification behavior which occurs in general flash sintering can be suppressed, and an achieved density can be improved as a result. Hereinafter, the name of this method will be referred to as Rate Control Flash.

### Manufacturing Method of Sintered Body

In a manufacturing method of a sintered body according to the present embodiment, zirconia (ZrO2) powder (TZ-3Y: produced by TOSOH CORPORATION, hereinafter may be referred to as “3YSZ”.) in which 3 mol % of yttria (Y2O3) was caused to be homogeneously dispersed in a solid solution was used as raw powder of ceramic. This raw powder was compacted, and a cuboidal sample (ceramic compact) having a length of 15 mm and a cross-sectional shape of 3.5 mm×3.5 mm was prepared by uniaxial and hydrostatic-pressure molding. After the sample was molded, platinum (Pt) foil serving as electrodes was fixed to longitudinal-direction both end faces of the sample by Pt paste.

Then, the sample to which the electrodes were fixed was set on a differential heat dilatometer (Thermo plus EVO2 TMA8301: produced by Rigaku Corporation) modified to enable connection of DC and AC power supplies. Then, the temperature was increased in a furnace while an electric field was applied to this sample.

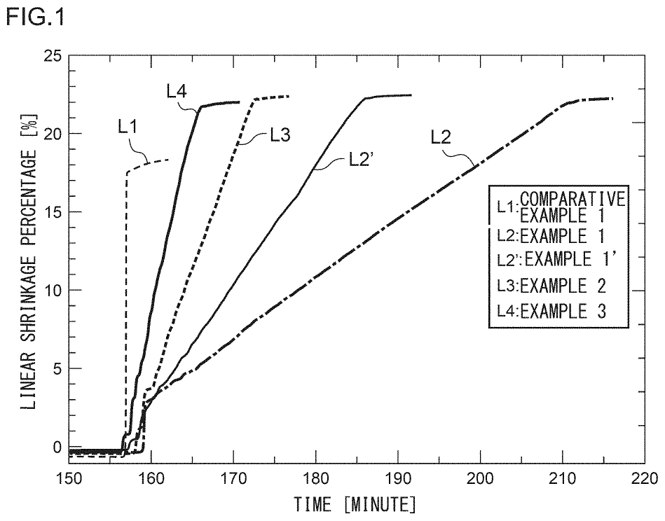

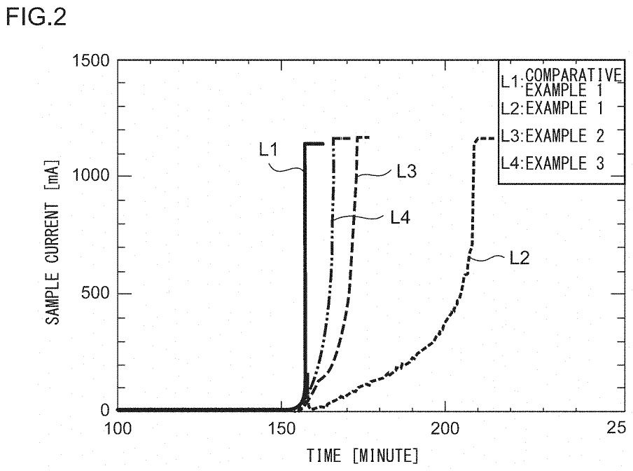

FIG. 1 is a diagram illustrating changes in linear shrinkage percentage in processes of manufacturing sintered bodies from samples. FIG. 2 is a diagram illustrating changes in sample currents caused by a conventional flash sintering method and Rate Control Flash.

A line L1 (Comparative Example 1) illustrated in FIG. 1 illustrates time changes of linear shrinkage percentage in the conventional flash sintering method. As illustrated by the line L1, in the conventional flash sintering method, when the temperature is increased in a state in which an electric field of a predetermined intensity is applied to the sample, the current which flows to the sample rapidly increases when the temperature is close to a flash sintering temperature (see a line L1 of FIG. 2), and sintering is completed in a short period of time. However, the linear shrinkage percentage of the obtained sintered body was about 18%, and there is room for improvement.

On the other hand, lines L2, L2′, L3, and L4 (Example 1, Example 1′, Example 2, and Example 3) illustrate time changes in linear shrinkage percentage of Rate Control Flash. In Rate Control Flash, for example, an electric field of 100 V/cm is applied to a sample, and, when the temperature becomes close to the flash sintering temperature of the electric field, the sample current rapidly increases. In this process, at a point when the sample current achieved an initial current limit value 100 mA, the sample current was increased up to 1200 mA while the sample current was controlled so that the sintering rate (linear shrinkage percentage) thereafter became constant (see FIG. 2). Note that the initial current limit value is not necessarily be 100 mA, but a lower value is preferred.

Note that the samples according to Example 1, Example 1′, Example 2, and Example 3 illustrated by the lines L2, L2′, L3, and L4 have mutually different rates (sintering rates) of increasing the current after the initial limit current value is reached. As illustrated by the lines L2, L2′, L3, and L4 of FIG. 1, it can be understood that the sintered bodies according to Example 1, Example 1′, Example 2, and Example 3 manufactured by Rate Control Flash obtained extremely high densities compared with the sintered body according to Comparative Example 1 manufactured by ordinary flash sintering. Particularly, the sintered body according to Example 1′ illustrated by the line L2′ has obtained the highest density among Examples of this time.

Note that a fact that the sintering rate of Rate Control Flash is constant can be confirmed by a fact that the time changes in the linear shrinkage percentage of FIG. 1 are almost linear (constant). Herein, the constant sintering rate does not require mathematical preciseness, and presence of certain degrees of errors, misalignment caused by control delay, and/or amplitude does not impair the nature of the invention. For example, if the inclination of each line illustrating the time changes in the linear shrinkage percentage (relative density) is within the range of about ±50% of a center value, the sintering rate may be considered to be constant.

In this manner, in the manufacturing method of a sintered body according to the first embodiment, instead of controlling the increase rate of the sample current to be constant, the sample current which flows to the ceramic compact is controlled so that the sintering rate becomes constant. In such control, it can be understood that current increases are gentle as illustrated by lines L2 to L4 instead of a rapid current increase like a line L1 illustrated in FIG. 2.

Also, if the manufacturing method of the sintered body of the first embodiment is expressed in other words, it can be also expressed as a method which controls the current which flows to the ceramic compact by a current profile determined so as to manufacture the ceramic sintered body having a density larger than a predetermined value (for example, a relative density of 90% or higher, linear shrinkage percentage of 20% or higher). Herein, the current profile means, for example, a relation between current-applied time and a sample current calculated by experiments and theoretical verifications, and the current profile may be stored in advance in a semiconductor memory or the like of a current controller. In this case, the necessity of acquiring the information of time changes of linear shrinkage percentage and subjecting the sample current to feedback control is eliminated, a detector which detects the linear shrinkage percentage can be omitted, and a control system can be simplified.

As described above, according to the manufacturing method of the sintered body according to the present embodiment, the sintered body which has a high density, which is difficult to be realized only by the conventional flash sintering method, can be manufactured in a comparatively short period of time.

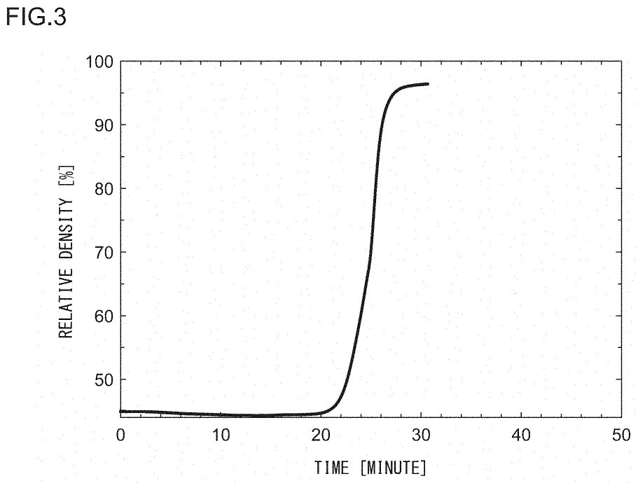

Next, in a case in which the sintering rate cannot be always configured to be constant like Rate Control Flash, the current increase rate in flash sintering may be configured to be constant. This flash sintering method is called Ramping Flash. A modification example in which Ramping Flash is applied to high-speed sintering will be described. FIG. 3 is a diagram illustrating changes in relative density in the case in which Ramping Flash is applied to high-speed sintering. In a manufacturing method according to the modification example, a temperature increase rate is 50° C./min which is rapid temperature increase, an electric field is an alternating current of 30 V/cm and 100 Hz, a sample current is 100 mA to 1000 mA, and a final furnace temperature is about 1200° C. While sintering of zirconia ceramic (3YSZ) generally takes several hours at a temperature of about 1500° C., a relative density of approximately 100% was obtained in only about 30 minutes from initiation of temperature increase of a ceramic compact to end of the sintering in the manufacturing method according to the modification example.

### Second Embodiment

A manufacturing method of a sintered body according to a second embodiment is one of flash sintering techniques which facilitates initial formation of a neck and further promotes densification. In this manufacturing method, a high application electric field is applied at the beginning of sintering, a compact is heated for a moment by Joule heat, and necks (contact portions) are formed between ceramic powder particles. If the electric field is kept being applied (this state is the same as general flash sintering), the flash phenomenon progresses at a low temperature, and the achieved density finally obtained becomes low.

In order to prevent this, in the manufacturing method according to the present embodiment, lowering the electric field and carrying out sintering immediately after the flash phenomenon occurs for a moment is a main characteristic of this technique. Hereinafter, the name of this method will be referred to as ICEFAST.

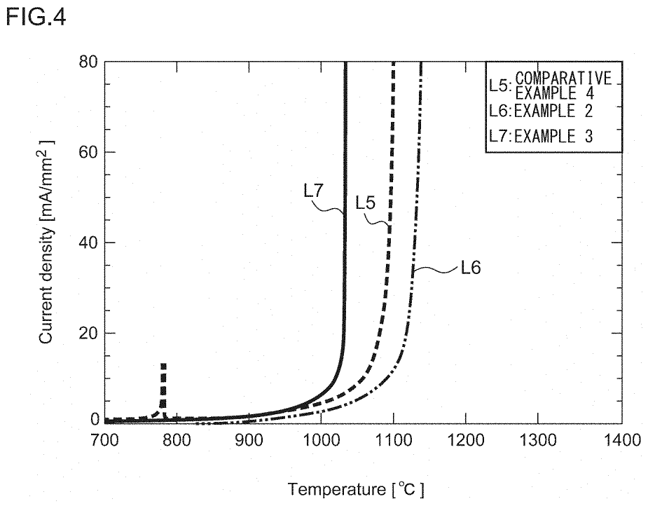

FIG. 4 is a diagram illustrating behaviors of sample currents of ICEFAST and a general flash sintering method. Sintering conditions of ICEFAST (line L5) illustrated in FIG. 4 are as following. First, temperature increase is started with an alternating current of 100 V/cm and a limit current value of 100 mA. A current spike is observed when the sample temperature is at a flash temperature (about 800° C.) in the case of the electric field 100 V/cm. This temperature matches the flash temperature of general flash sintering under the condition that 100 V/cm is applied. Therefore, the sample current tries to largely increase. However, since the limit current value is set to 100 mA in advance, the flash phenomenon is limited until this current value.

In other words, since the sample current at the flash temperature is limited to 100 mA in ICEFAST, the sample current does not largely increase like general flash sintering. The applied electric field is lowered to 30 V/cm at the point when this flash phenomenon occurs, and temperature increase is subsequently continued. Note that lines L6 and L7 illustrated in FIG. 4 illustrate behaviors of sample currents in the conventional flash sintering method in the cases in which the electric fields are 30 V/cm and 40 V/cm, respectively.

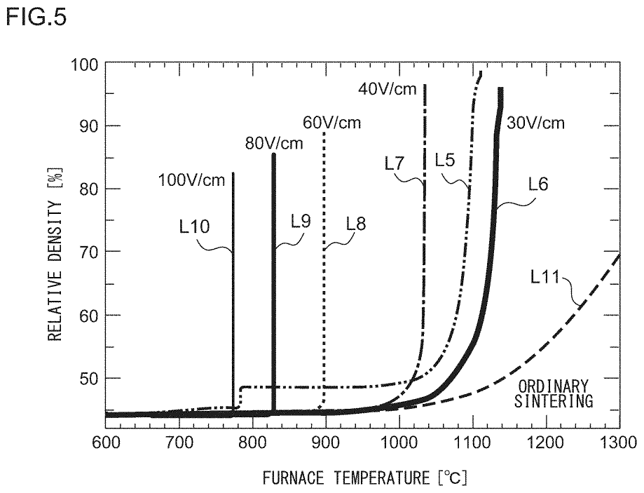

FIG. 5 is a diagram illustrating changes in relative density in processes of manufacturing sintered bodies from samples.

FIG. 5 illustrates sintering curves of general sintering (line L11: Comparative Example 7), general flash sintering (lines L6 to L10: Comparative Examples 2 to 6), and ICEFAST (line L5: Example 4).

First, in ordinary sintering of Comparative Example 7, the relative density is about 70% even when the temperature is increased to about 1300° C. On the other hand, in general flash sintering (Comparative Examples 2 to 6), the achieved density is improved with any of the electric fields. Also, it can be confirmed that, as the applied electric field increases, the flash temperature transitions to a lower temperature side. In general flash sintering, reduction in the achieved density regardless of a high applied electric field is caused by a difference in the flash temperature. It can be understood from this comparison that a high Joule heating amount does not always result in a high achieved density obtained by the influence of a furnace temperature.

On the other hand, ICEFAST (Example 4) of 30 V/cm includes: a first process of, in a case that temperature increase is carried out while an electric field is applied to a ceramic compact, carrying out the temperature increase while applying an electric field of 100 V/cm to the ceramic compact up to a flash sintering temperature (about 800° C.) at which a current flowing to the ceramic compact rapidly increases; and a second process of carrying out temperature increase while applying an electric field of 30 V/cm smaller than the electric field of 100 V/cm after the current flowing to the ceramic compact has rapidly increased and achieved a predetermined limit current value of 100 mA.

By virtue of this, in the manufacturing method according to the present embodiment, the sintered body which has a high density, which is difficult to be realized only by the conventional flash sintering method, can be manufactured in a comparatively short period of time.

### Manufacturing Apparatus of Sintered Bodies

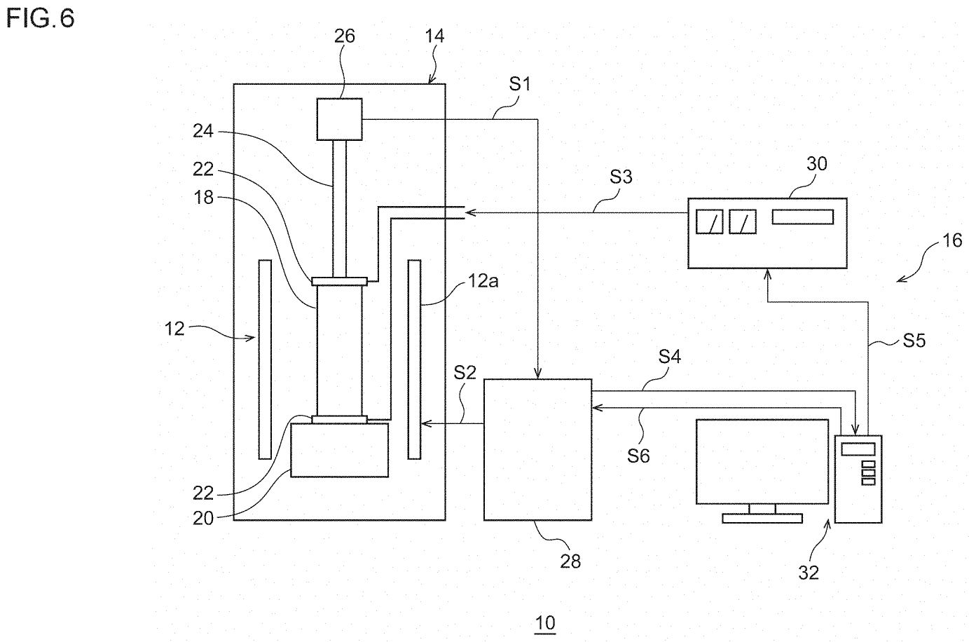

A manufacturing apparatus suitable for the manufacturing methods of the sintered bodies according to the above described embodiments will be further described in detail. FIG. 6 is a diagram illustrating a rough configuration of a manufacturing apparatus of a sintered body according to an embodiment. The manufacturing apparatus 10 is provided with an apparatus main body 14, which has an electric furnace 12 for increasing the temperature to sinter a ceramic compact, and a control system 16, which controls set parameters of manufacturing processes of the apparatus main body 14.

The apparatus main body 14 is provided with a heater 12a used in the electric furnace 12, a sample 18 including a ceramic compact, a sample stage 20 on which the sample 18 is placed, electrodes 22 disposed at both ends of the sample 18 to apply a voltage to the sample 18, a rod 24 which moves depending on the volume change of the ceramic compact, and a detector 26 which detects the length (density) of the sample 18 from the movement of the rod 24. For example, a thermal dilatometer is used as the detector 26.

The control system 16 is provided with: a first arithmetic device 28, which acquires the information related to the length (density) of the sample 18 from the detector 26 via a signal line S1 and, on the basis of the information, calculates a control signal which controls the output of the heater 12a via a signal line S2; a power supply 30, which applies a voltage between the pair of electrodes 22 and controls the current flowing to the sample 18 via a signal line S3; and a second arithmetic device 32, which calculates the rate of shrinkage percentage of the sample 18 on the basis of the information acquired from the detector 26 via a signal line S4. The first arithmetic device 28 and the second arithmetic device 32 are, for example, personal computers which have storages such as semiconductor memories.

The second arithmetic device 32 controls the voltage and the current value, which are to be applied to the ceramic compact, by the power supply 30 via a signal line S5 on the basis of the calculated rate of shrinkage percentage (sintering rate) and, furthermore, controls the output of the electric furnace 12 of the apparatus main body 14 by the first arithmetic device 28 via a signal line S6.

The manufacturing apparatus 10 according to the present embodiment can manufacture a ceramic sintered body having a density higher than a conventional one by the feedback control as described above. In addition, in manufacturing of the ceramic sintered body, the information of a current profile applied to the sample 18 and an appropriate temperature increase profile (temperature increase rate) of heating of the sample 18 is created, and these profiles can be stored in the storages of the arithmetic devices.

Specifically, the voltage is applied to the ceramic compact by using the power supply 30 while the temperature of the ceramic compact is increased by the heater of the electric furnace 12, the length of the ceramic compact is detected by the detector 26, and the current which flows to the sample 18 is measured at the power supply 30. In this process, the time changes (shrinkage rates) of the length of the sample 18 are stored in the storage.

When the current value of the sample 18 starts increasing and the shrinkage rate of the sample 18 starts increasing, on the basis of the data thereof, the second arithmetic device 32 controls the limit value of the current value, controls the voltage value, or controls the electric power value, which is applied to the sample 18, by using the power supply 30 so that the shrinkage rate becomes constant. Furthermore, the output of the electric furnace 12 is controlled by using the first arithmetic device 28.

As described above, the manufacturing apparatus 10 of the sintered body according to the present embodiment is provided with: the heater 12a which heats the ceramic compact, the electrodes 22 for applying a voltage to the ceramic compact, the power supply 30 which applies the voltage to the electrodes 22 so that a predetermined current flows to the ceramic compact, the storage which stores the current profile determined so as to manufacture the ceramic sintered body having a density higher than a predetermined value, and the first arithmetic device 28 and the second arithmetic device 32 which controls a voltage applier on the basis of the current profile while increasing the temperature of the ceramic compact by the heater 12a.

As a result, when a ceramic sintered body is manufactured by the manufacturing apparatus 10, the shrinkage rate of the sample 18, the temperature of the sample 18, the voltage, current, and electric power applied to the sample 18, the output and temperature of the electric furnace, and so on in the manufacturing are recorded in the storages of the first arithmetic device 28, the power supply 30, and the second arithmetic device 32.

By storing the current profile, which has been calculated in advance from experiments and calculations, in the storage in this manner, the ceramic sintered body having a higher density than a predetermined value can be manufactured without carrying out feedback control. Therefore, the necessity of a detection device or an arithmetic device for finding out the sintering rate for feedback control is eliminated, and the apparatus can be simplified.

Therefore, by using the profiles stored in the storages, the manufacturing apparatus 10 can manufacture a ceramic sintered body having a density higher than a predetermined value on the basis of the profiles without carrying out feedback control thereafter. Alternatively, by utilizing the profiles, which are stored in the storages, by another manufacturing apparatus, a ceramic sintered body having a density higher than a predetermined value can be manufactured even by a simple manufacturing apparatus which does not have a configuration for feedback control. Structure of Sintered Body manufactured by Rate Control Flash

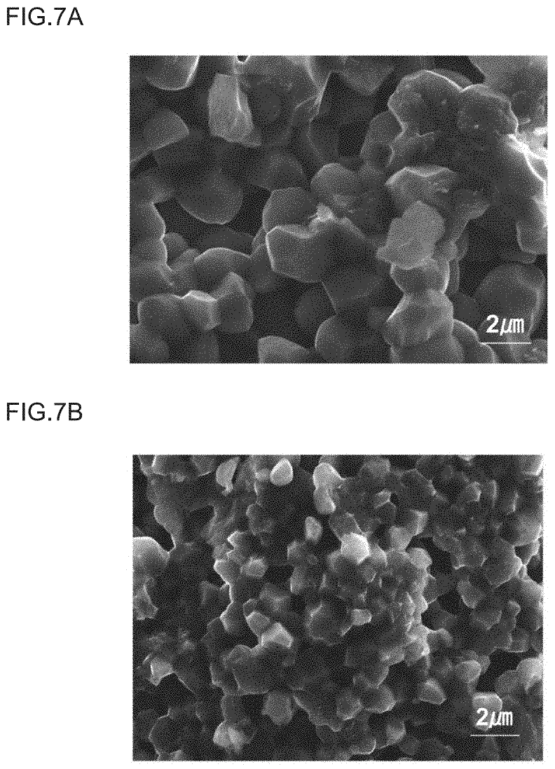

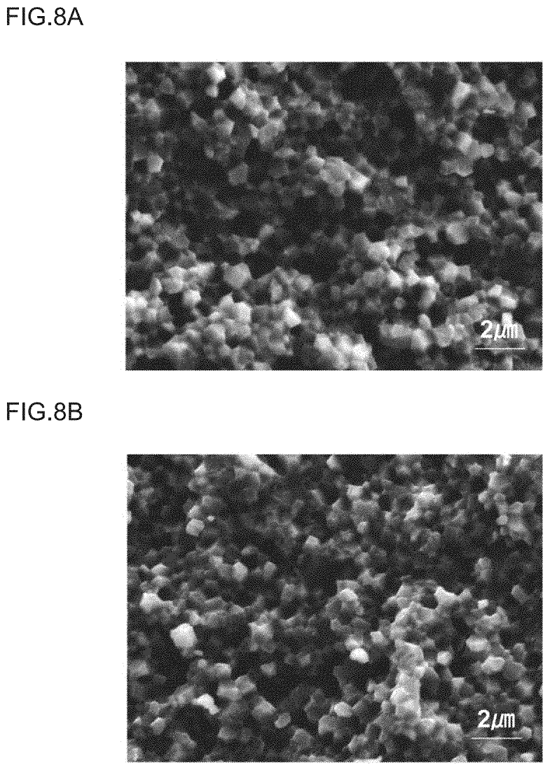

Next, the influence exerted by the differences in the manufacturing method on structures and compositions of sintered bodies will be described. FIG. 7(a) is a diagram illustrating a scanning electron micrograph of a center portion of a sintered body manufactured by the flash sintering method, and FIG. 7(b) is a diagram illustrating a scanning electron micrograph of an outer peripheral portion of the sintered body manufactured by the flash sintering method. FIG. 8(a) is a diagram illustrating a scanning electron micrograph of a center portion of a sintered body manufactured by Rate Control Flash, and FIG. 8(b) is a diagram illustrating a scanning electron micrograph of an outer peripheral portion of the sintered body manufactured by Rate Control Flash.

An average value of a crystal grain size d of the structure of the center portion of the sintered body manufactured by the flash sintering method is 2.25 μm which is comparatively large as illustrated in the photograph of FIG. 7(a). On the other hand, an average value of the crystal grain size d of the structure of the outer peripheral portion of the sintered body manufactured by the flash sintering method is 1.25 μm, which is smaller by about 55% compared with the crystal grain size of the center portion as illustrated in the photograph of FIG. 7(b).

On the other hand, an average value of the crystal grain size d of the structure of the center portion of the sintered body manufactured by Rate Control Flash is 0.60 μm which is extremely small as illustrated by the photograph of FIG. 8(a). Also, an average value of the crystal grain size d of the structure of the outer peripheral portion of the sintered body manufactured by Rate Control Flash is 0.58 μm which is approximately the same as the crystal grain size of the center portion as illustrated by the photograph of FIG. 8(b). In other words, the sintered body manufactured by Rate Control Flash has extremely fine crystal grain sizes, and the crystal grain sizes are homogeneous across the entire sintered body.

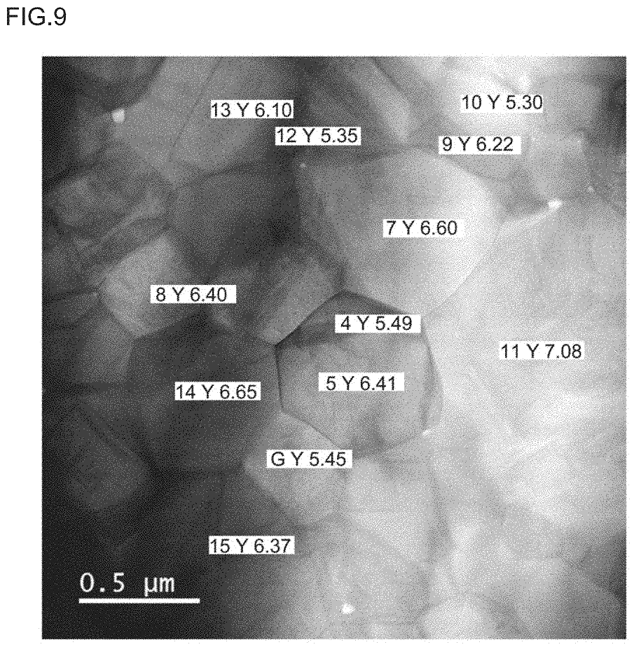

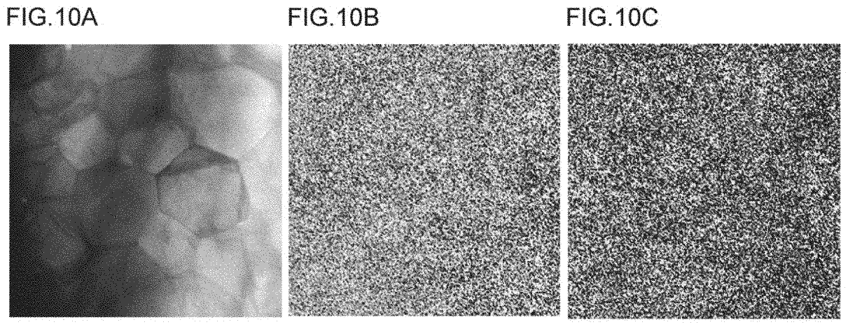

Next, composition distributions of a sintered body will be described. FIG. 9 is a diagram illustrating a transmission electron micrograph of a sintered body manufactured by Rate Control Flash and results of composition analysis of yttrium in a predetermined region. FIG. 10(a) is the transmission electron micrograph illustrated in FIG. 9, and FIG. 10(b) is a diagram illustrating mapping of the element of zirconium by Energy Dispersive X-ray Spectroscopy (EDS) in the region illustrated in FIG. 10(a) and is a diagram illustrating mapping of the element of yttrium by EDS in the region illustrated in FIG. 10(a).

“4_Y 5.49”, “5_Y 6.41”, “6_Y 5.45”, “7_Y 6.60”, “8_Y 6.40”, “9_Y 6.22”, “10_Y 5.30”, “11_Y 7.08”, “12_Y 5.35”, “13_Y 6.10”, “14_Y 6.65”, and “15_Y 6.37” illustrated in the photograph of FIG. 9 are EDS analysis of the composition [at %] of yttrium (Y) in the polycrystalline structure in the entire view field illustrated in the photograph, and it means that the analysis was carried out 12 times. The average value thereof is 6.12 [at %] and is 3.06 [mol %] in Y2O3 conversion. Therefore, it can be understood that the sample illustrated in FIG. 9 almost matches the composition of zirconia (ZrO2) in which 3 mol % of yttria (Y2O3) is solid solution as raw powder. Also, as illustrated in FIG. 10(b) and FIG. 10(c), in the region of the photograph illustrated in FIG. 10(a), unevenness in the distribution of zirconium and yttrium is extremely small.

As described above, in the sintered body manufactured by Rate Control Flash, the homogeneity of the size of crystal grains and homogeneity of compositions are extremely high, and the density and characteristics which are difficult to be achieved by the conventional manufacturing method can be obtained.

### Third Embodiment

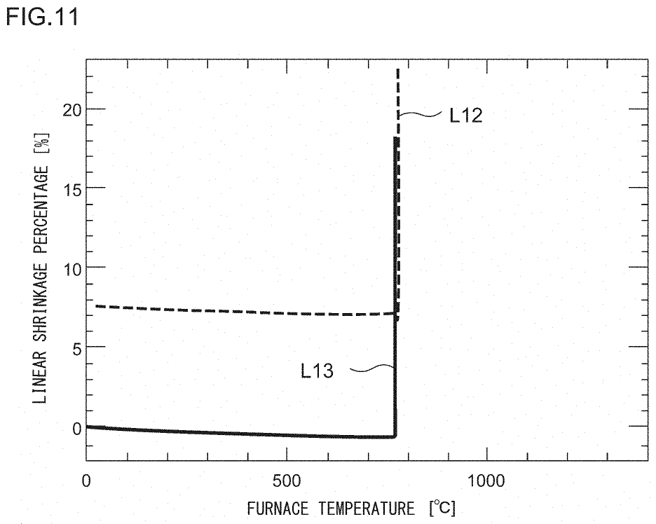

A manufacturing method according to a third embodiment is a method in which calcination is once carried out in a sintering initial process (for example, sintering starts in a temperature range of about 800 to 1200° C. in a case of 3YSZ) which affects the final density of a sintered body, the temperature is lowered to a low temperature thereafter, and, then, the sintered body is manufactured by a flash sintering method. FIG. 11 is a graph illustrating a relation (line L12) between the linear shrinkage percentage of a sample, which has been manufactured by the flash sintering method after the calcination of the manufacturing method according to the third embodiment, and a furnace temperature.

Specifically, the temperature of a compact of 3YSZ is increased to a temperature at which sintering starts (1200° C. in the present embodiment), and, without particularly maintaining the temperature, the temperature of the compact of 3YSZ which has undergone the temperature increase is lowered to a temperature equal to or lower than a predetermined temperature. Herein, the temperature equal to or lower than the predetermined temperature is, for example, equal to or lower than a flash sintering temperature and is a temperature equal to or less than 780° C. in the present embodiment. Then, the compact of 3YSZ at the lowered temperature is subjected to temperature increase while applying a predetermined electric field (100 V/cm, 100 Hz).

As a result, as illustrated by the line L12 of FIG. 11, the linear shrinkage percentage at the flash sintering temperature is significantly improved compared with a sintered body (line L13) manufactured only by the flash sintering method. As a result, the sintered body manufactured by the manufacturing method according to the present embodiment shows an extremely high value of relative density, which is 99.6%.

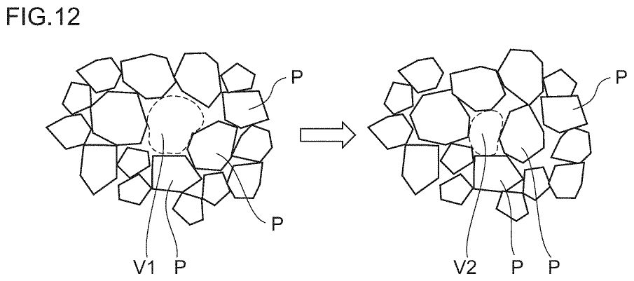

A conceivable reason why the sintered body of such a high density was obtained is that the time to eliminate the inhomogeneity in rearrangement of the raw powder and neck formation formed between particles, which occurs in the sintering initial process, is obtained in the stage of calcination. FIG. 12 is a schematic diagram for describing the rearrangement of particles and inhomogeneous neck formation in the stage of calcination.

As illustrated in the left diagram of FIG. 12, at the point when the raw powder is only compacted, plural particles P are caught by one another, and a large void V1 is formed inside. This state in which the plural particles P are caught by one another in this way is sometimes referred to as bridging. When calcination is carried out at a temperature of around 1000° C. in this state, surface diffusion of the particles P becomes notable, and the particles P change the positions thereof little by little as illustrated in the right diagram of FIG. 12. As a result, the bridging is disengaged, the void V1 which has been large becomes a small void V2, and this is conceivably a factor which increases the density of the sintered body. Also, the neck formation which occurs at the point of initial sintering occurs homogeneously, and formation of voids larger than particle diameters is suppressed as a result.

### Fourth Embodiment

A manufacturing method according to a fourth embodiment includes a characteristic that the process of calcination according to the third embodiment is carried out by above described Rate Control Flash. For example, the manufacturing method of a sintered body according to the present embodiment includes: a temperature increasing process of increasing a temperature of a ceramic compact to a predetermined temperature; an application process of applying a predetermined electric field to the ceramic compact until the temperature achieves the predetermined temperature; a first current control process of controlling a current flowing to the ceramic compact so that a sintering rate becomes constant after the current flowing to the ceramic compact achieves a first current value in the process of applying the electric field; and a second current control process of increasing the current flowing to the ceramic compact to a second current value higher than the first current value after the first current control process is executed for a predetermined period of time.

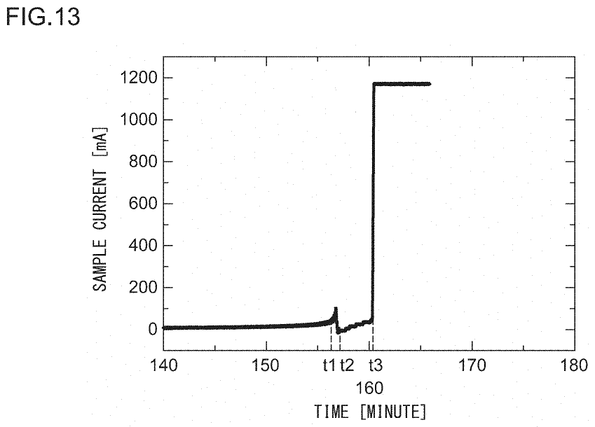

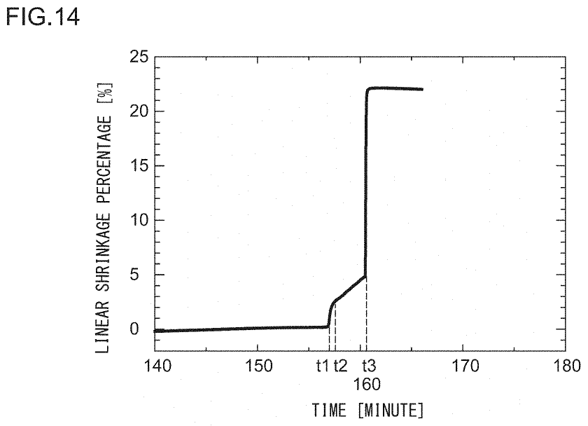

FIG. 13 is a graph illustrating changes in linear shrinkage percentage in the manufacturing method according to the fourth embodiment. FIG. 14 is a graph illustrating changes in a sample current in the manufacturing method according to the fourth embodiment. Time (t1, t2, and t3) of horizontal axes of FIG. 13 and FIG. 14 corresponds to mutually the same time.

Next, a specific example of the manufacturing method according to the fourth embodiment will be described. First, a compact of 3YSZ is subjected to temperature increase at a temperature increase rate of 300° C./h, and an alternating-current electric field of 100 V/cm and 100 Hz is applied at the point of time (time tl) when the temperature achieves about 780° C. At this point of time, the sample current rises to 100 mA (this value is a limit current value set in advance) for a moment. Next, at the time t2, Rate Control Flash is carried out for about 5 minutes (to the time t3) so that the sintering rate becomes constant. Then, at the time t3, the limit current value is increased at once to 1200 mA. As a result, the sintered body manufactured by the manufacturing method according to the present embodiment becomes the sintered body having an extremely high density.

### Fifth Embodiment

In a manufacturing method of a sintered body according to the present embodiment, zirconia (ZrO2) powder (TZ-8Y: produced by TOSOH CORPORATION, hereinafter may be referred to as “8YSZ”.) in which 8 mol % of yttria (Y2O3) was caused to be homogeneously dispersed in a solid solution was used as raw powder of ceramic. Hereinafter, the conditions different from the first embodiment will be mainly described.

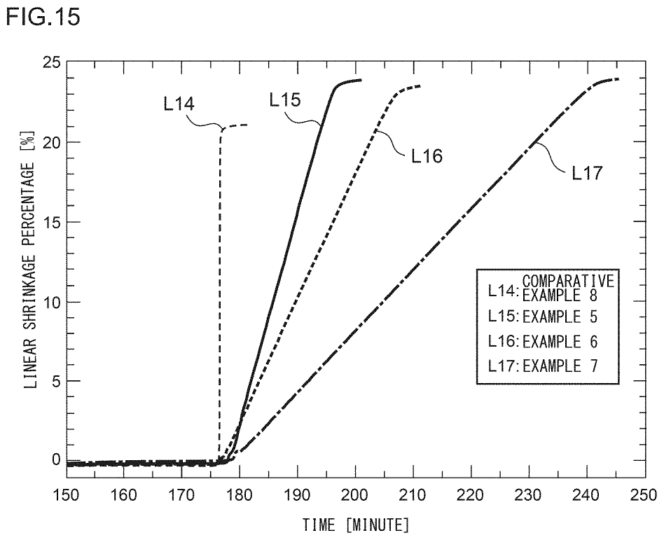

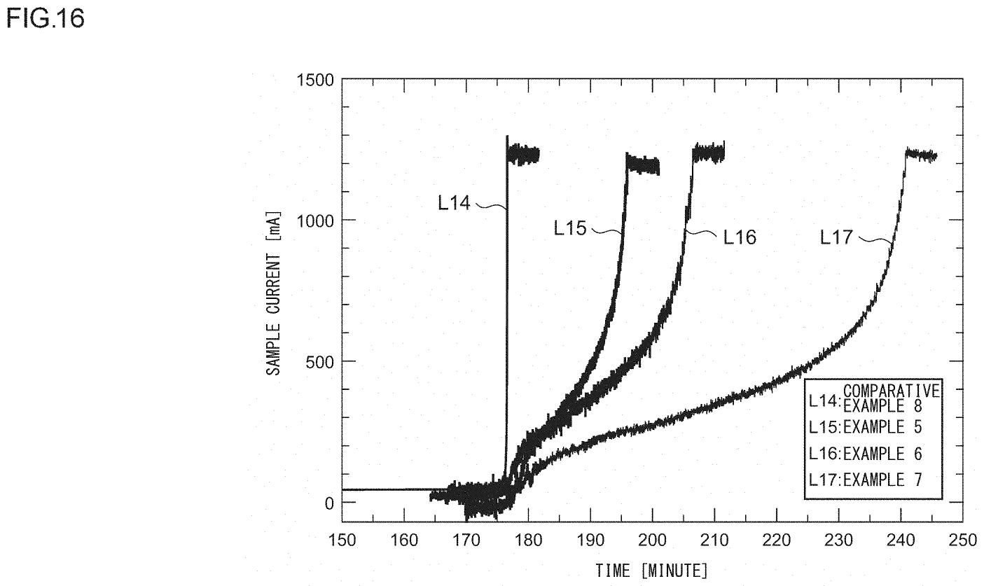

FIG. 15 is a diagram illustrating changes in linear shrinkage percentage in processes of manufacturing sintered bodies from samples. FIG. 16 is a diagram illustrating changes in sample currents caused by a conventional flash sintering method and Rate Control Flash.

A line L14 (Comparative Example 8) illustrated in FIG. 15 illustrates time changes of linear shrinkage percentage in the conventional flash sintering method. As illustrated by the line L14, in the conventional flash sintering method, when the temperature is increased in a state in which an electric field of a predetermined intensity is applied to the sample, the current which flows to the sample rapidly increases when the temperature is close to a flash sintering temperature (see a line L14 of FIG. 16), and sintering is completed in a short period of time. However, the relative density of the obtained sintered body was about 80%, and there is room for improvement.

On the other hand, lines L15, L16, and L17 (Example 5, Example 6, and Example 7) illustrate time changes in linear shrinkage percentage of Rate Control Flash. In Rate Control Flash, for example, an electric field of 50 V/cm is applied to a sample, and, when the temperature becomes close to the flash sintering temperature of the electric field, the sample current rapidly increases. In this process, at a point when the sample current achieved an initial current limit value 100 mA, the sample current was increased up to 1200 mA while the sample current was controlled so that the sintering rate thereafter became constant (see FIG. 16). Note that the initial current limit value is not necessarily be 100 mA, but a lower value is preferred.

Note that the samples according to Example 5, Example 16, and Example 7 illustrated by the lines L15, L16, and L17 have mutually different rates (sintering rates) of increasing the current after the initial limit current value is reached. Specifically, the sintering rate (linear shrinkage percentage) is 200 μm/min in Example 5, is 120 μm/min in Example 6, and is 60 μm/min in Example 7. As illustrated by the lines L15, L16, and L17 of FIG. 16, it can be understood that the sintered bodies according to Example 15, Example 16, and Example 17 manufactured by Rate Control Flash obtained extremely high densities compared with the sintered body according to Comparative Example 8 manufactured by ordinary flash sintering.

Note that a fact that the sintering rate of Rate Control Flash is constant can be confirmed by a fact that the time changes in the relative density of FIG. 16 are almost linear (constant).

### Sixth Embodiment

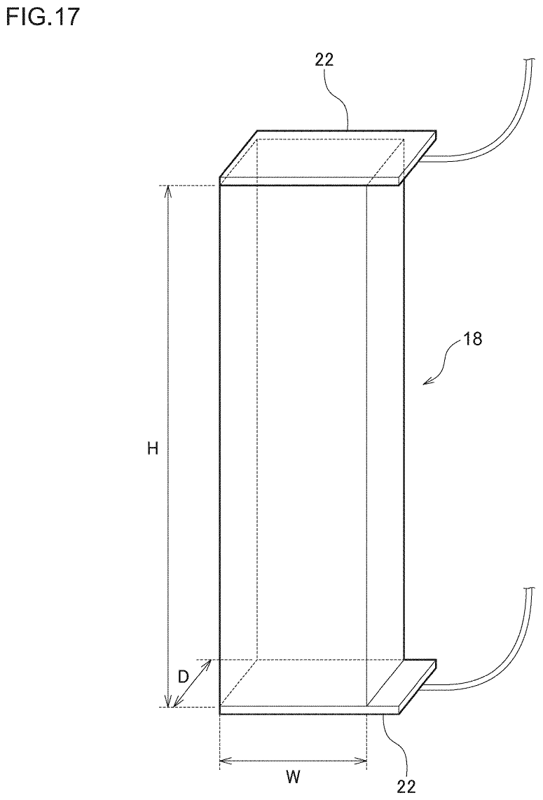

An important factor of the shapes of sintered bodies created in researches or experiments is that they are easy to be made, and practical shapes are not taken into consideration in many cases. However, when practicality as a manufactured sintered body is taken into consideration, a cuboid or a columnar shape is preferred. FIG. 17 is a perspective view illustrating outlines of a cuboidal ceramic compact provided between a pair of electrodes.

The sample 18 including the ceramic compact illustrated in FIG. 17 is a cuboid having a depth D [mm], a width W [mm], and a height H [mm], and the pair of electrodes 22 is provided at both ends in the height direction. In this case, the electrodes 22, which carry out electric field application, are in contact with the end faces of the sample 18 including the ceramic compact. Therefore, if the heat resistance of this part is low, the amount of electric power which can be applied to the sample 18 is limited. Therefore, a technique capable of achieving a high final achieved density of the sintered body with the applied electric power which is as low that does not melt the electrodes is required.

The manufacturing method of the sintered body of the present disclosure is capable of carrying out manufacturing with the applied electric power, which is lower than the applied electric power used in a general sintering method, and is capable of reducing melting of the electrodes. A particularly-focused-on point is that a sintered body having a higher sinter density can be manufactured by using an alternating-current electric field in the flash sintering method compared with a case in which a direct-current electric field is used.

The inventors of the present application focused on these facts, diligently carried out studies to realize a sintered body having a high density, which has been difficult to be realized only by the conventional flash sintering method, and conceived of a novel manufacturing method of a sintered body.

### Manufacturing Method of Sintered Body

In a manufacturing method of a sintered body according to a sixth embodiment, zirconia (ZrO2) powder (TZ-3Y: produced by TOSOH CORPORATION, hereinafter may be referred to as “3YSZ”.) in which 3 mol % of yttria (Y2O3) was caused to be homogeneously dispersed in a solid solution was used as raw powder of ceramic. This raw powder was compacted, and a cuboidal sample (ceramic compact) having a length of 15 mm and a cross-sectional shape of 7 mm×7 mm was prepared by uniaxial and hydrostatic-pressure molding. After the sample was molded, platinum (Pt) foil serving as electrodes was fixed to longitudinal-direction both end faces of the sample by Pt paste.

Then, the sample to which the electrodes were fixed was set on a differential heat dilatometer (Thermo plus EVO2 TMA8301: produced by Rigaku Corporation) modified to enable connection of DC and AC power supplies. Then, the temperature was increased in a furnace while an electric field was applied to this sample.

At the sample 18 illustrated in FIG. 17, Pt foil serving as the electrodes 22 is in direct contact with the ceramic compact. Therefore, the amount of electric power which can be applied upon electric field application is limited to the range which does not exceed the temperature at which the metal (Pt) used in the electrodes melt. Therefore, the inventors of the present application focused on the alternating-current electric field. Hereinafter, an example in which raw powder of the ceramic compact containing zirconium oxide as a main component is described as an example. However, it goes without saying that the manufacturing method of the sintered body of the present disclosure can be applied also to sintered bodies using other compounds as raw powder.

### Differences in Effects of Direct-Current Electric Field and Alternating-Current Electric Field

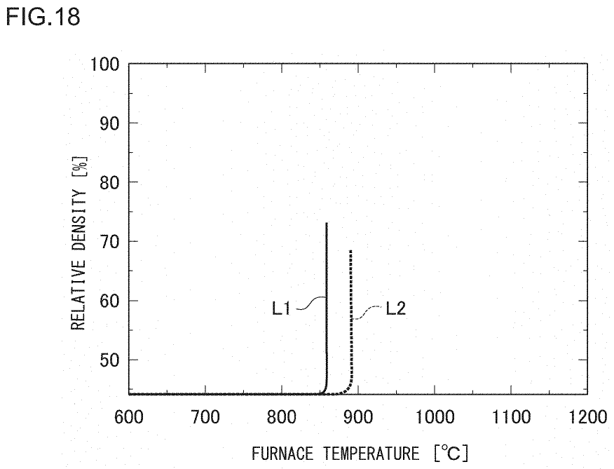

FIG. 18 is a diagram illustrating changes in relative densities in the cases in which a direct-current electric field and an alternating-current electric field having the same size of electric field are applied in the flash sintering method. A line L1 illustrated in FIG. 18 illustrates time changes in the relative density in the flash sintering method in which the alternating-current electric field (50 V/cm, 1 Hz, limit current value 900 mA) was applied. A line L2 is a diagram illustrating time changes in the relative density in the flash sintering method in which the direct-current electric field (50 V/cm, limit current value 900 mA) was applied. Note that a cross section of each sample has a depth D of 7 mm and a width W of 7 mm. Hereinafter, a sample has a cross section of the same size unless otherwise stated.

As illustrated in FIG. 18, it can be understood that the relative density in the case (line L1) in which the alternating-current electric field was applied is high. Conceivable reasons thereof are as following. In application of the direct-current electric field, ion streams occur in one direction. Therefore, strong reduction occurs from the ceramic compact which is close to a negative electrode side of the pair of electrodes, nitriding or the like occurs in atmospheric air in some cases, and densification is significantly disturbed. Furthermore, inhomogeneity (deformation) in the sample shape also occurs. On the other hand, in the application of the alternating-current electric field, unbalance in the ion streams like that in the direct-current electric field does not occur, and densification therefore progresses more homogeneously.

Herein, in the case of the direct-current electric field, if higher electric power is applied to the sample 18 in order to improve the achieved density of the sintered body, the Pt foil used in the electrodes 22 melts in some cases. Therefore, a high achieved density cannot be obtained by the direct-current electric field. Particularly, the larger the cross sectional area of the ceramic compact, the more notable the tendency of melting.

### Influence of Frequency of Alternating-Current Electric Field exerted on Achieved Density

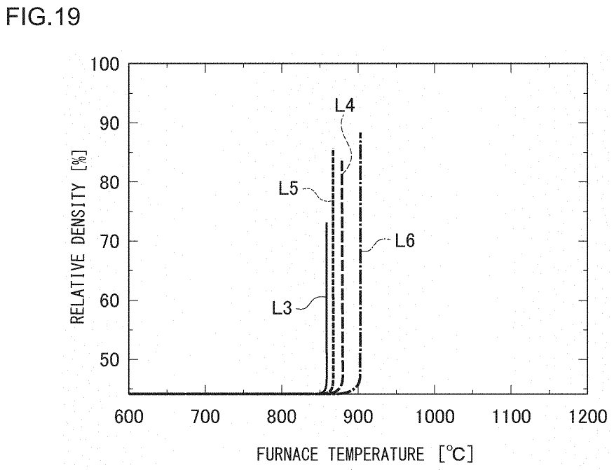

FIG. 19 is a diagram illustrating changes in relative densities in the cases in which the frequency of the alternating-current electric field was changed while using the same electric field and the same limit current value. A line L3 to a line L6 illustrated in FIG. 19 illustrate the cases in which the frequencies are 1 Hz, 10 Hz, 100 Hz, and 1000 Hz, respectively. As is understood from FIG. 19, the higher the frequency of the alternating-current electric field, the higher the achieved density.

### Frequency Dependency of Alternating-Current Electric Field Related to the Amount of Electric Power which can be applied to Improve Achieved Density

In order to improve the achieved density of the sintered body, it is necessary to apply higher electric power. However, if a cuboidal ceramic compact as illustrated in FIG. 17 is used, the amount of electric power is limited to obtain a temperature range which does not melt the electrodes.

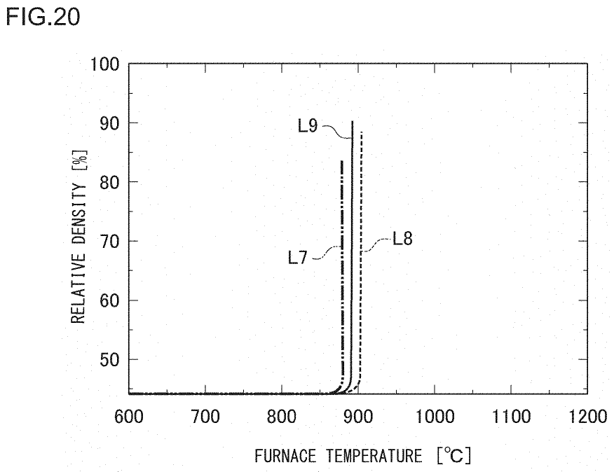

Therefore, the inventors of the present application has found out that, in the case of the alternating-current electric field, a higher frequency enables application of higher electric power while suppressing melting of the electrodes. FIG. 20 is a diagram illustrating changes in relative densities in the cases in which alternating-current electric fields having different frequencies and limit current values are applied. A line L7 illustrates the case in which the alternating-current electric field having a frequency of 10 Hz and a limit current value of 900 mA was applied, and the relative density is less than 85%. Also, in the case in which the alternating-current electric field having a frequency of 10 Hz and a limit current value of 1000 mA was applied, the electrodes melted, and sufficient sintering was not carried out. On the other hand, in the case in which the alternating-current electric field having a frequency of 1000 Hz and a limit current value of 900 mA was applied (line L8), the relative density of the sintered body exceeded 85%. Also, in the case in which the alternating-current electric field having the frequency of 1000 Hz and a limit current value of 1100 mA was applied (line L9), the applied electric power was increased without melting the electrodes, and, as a result, the relative density of the sintered body exceeded 90%. In this manner, with the sample at which the electrodes contact the cuboidal ceramic compact, higher electric power can be applied when the alternating-current electric field of a higher frequency is used, and, as a result, the achieved density of the sintered body can be improved.

### Influence of Cross Sectional Area of Ceramic Compact

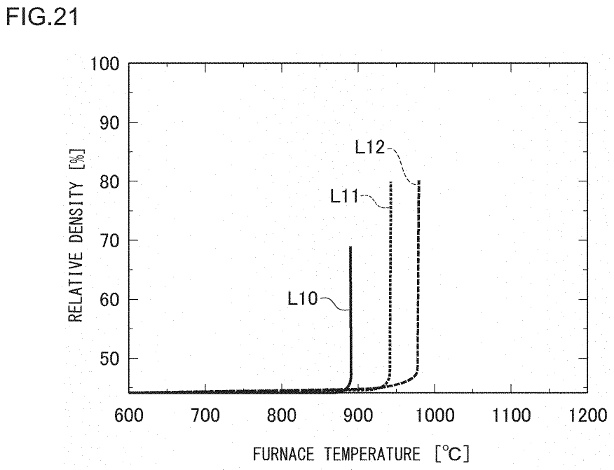

It has been found out that the behavior of the sample current in the flash sintering method depends on the cross sectional area of the ceramic compact. FIG. 21 is a diagram illustrating changes in relative densities in the cases in which direct-current electric fields are applied to ceramic compact samples having different cross sectional areas. A line L10 illustrates changes in the relative density in the case in which the direct-current electric field having an electric field of 50 V/cm and a limit current value of 900 mA was applied to the sample having a cross sectional area of 7×7 mm, a line L11 illustrates changes in the relative density in the case in which the direct-current electric field having an electric field of 50 V/cm and a limit current value of 816 mA was applied to the sample having a cross sectional area of 5×5 mm, and a line L12 illustrates changes in the relative density in the case in which the direct-current electric field having an electric field of 50 V/cm and a limit current value of 400 mA was applied to the sample having a cross sectional area of 3.5×3.5 mm. According to these results, it can be understood that the larger the cross sectional area, the lower the flash temperature.

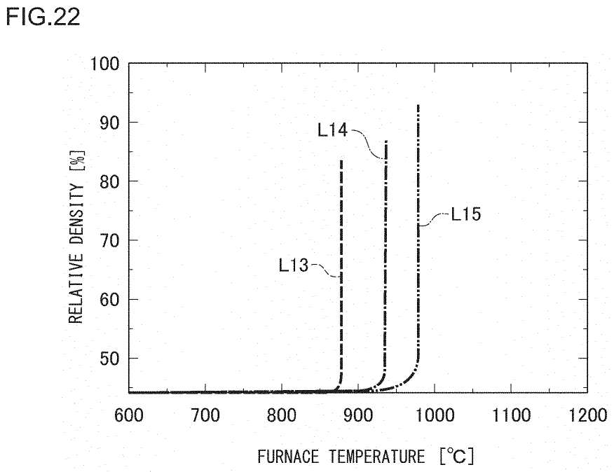

FIG. 22 is a diagram illustrating changes in relative densities in the cases in which alternating-current electric fields are applied to ceramic compact samples having different cross sectional areas. A line L13 illustrates changes in the relative density in the case in which the alternating-current electric field having an electric field of 50 V/cm, a frequency of 10 Hz, and a limit current value of 900 mA was applied to the sample having a cross sectional area of 7×7 mm, a line L14 illustrates changes in the relative density in the case in which the alternating-current electric field having an electric field of 50 V/cm, a frequency of 10 Hz, and a limit current value of 816 mA was applied to the sample having a cross sectional area of 5×5 mm, and a line L15 illustrates changes in the relative density in the case in which the alternating-current electric field having an electric field of 50 V/cm, a frequency of 10 Hz, and a limit current value of 400 mA was applied to the sample having a cross sectional area of 3.5×3.5 mm.

It can be understood that all of the samples to which the alternating-current electric fields were applied had larger achieved densities compared with the same samples to which the direct-current electric fields were applied. On the other hand, the larger the cross sectional areas of the samples, the lower the achieved densities. Therefore, the larger the cross sectional area of the ceramic compact sample, the higher the necessity of improving the applied electric power, and increasing the frequency of the alternating-current electric field is effective as a method therefof.

### About Control of Alternating-Current Electric Field

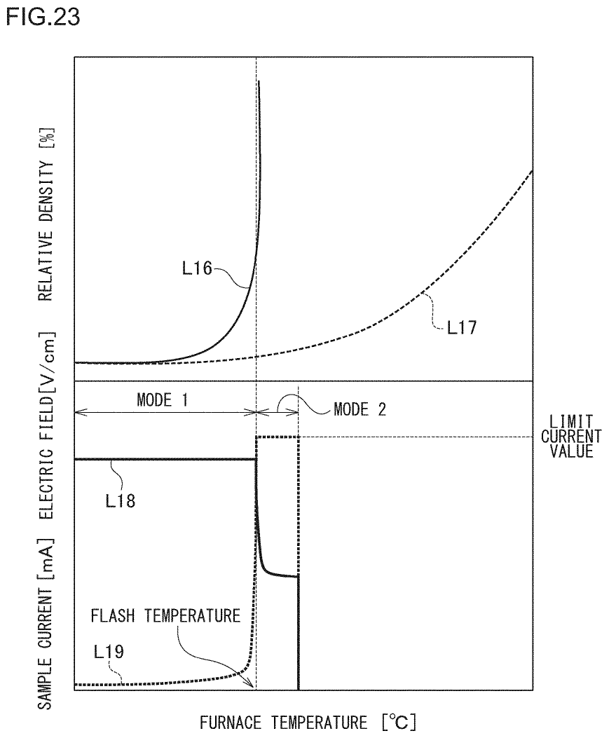

FIG. 23 is a diagram for qualitatively describing the relation between electric fields and sample currents in the flash phenomenon. A line L16 illustrated in FIG. 23 illustrates changes in the relative density of a sintered body according to the flash sintering method, and a line L17 illustrates changes in the relative density of a sintered body according to an ordinary sintering method in which an electric field is not applied. Also, a line L18 illustrates changes in the electric field in the flash sintering method, and a line L19 illustrates changes in the sample current in the flash sintering method.

In the flash sintering method, the temperature is increased in a state in which a constant electric field is applied to a ceramic compact. In this process, a limit current value, which is an upper limit of the sample current value, is set in advance. The temperature of the electric furnace increases, the flash phenomenon occurs when the temperature reaches the flash temperature, and the relative density largely increases along with that.

As illustrated in FIG. 23, the electric field and the sample current largely change before and after the flash phenomenon. Generally, a stabilizing power supply is used for the application of the electric field to the sample and control of the sample current. In the range in which a constant voltage is applied at a temperature lower than the flash temperature, a control mode of this power supply is a voltage control mode (Mode 1 of FIG. 23). As illustrated in FIG. 23, in the temperature range equal to or lower than the flash temperature, the resistance of the ceramic compact is high, and almost no sample current flows. Then, when the temperature reaches the flash temperature, the resistance of the sample largely reduces, and the sample current value rapidly increases along with that (line L19).

This sample current increases up to the limit current value set in advance. At the point of time when the sample current reaches the limit current value, the stabilizing power supply automatically transitions from the voltage control mode to a current control mode (Mode 2 of FIG. 23). Thereafter, the power supply carries out control so as to have a constant current value. Therefore, the applied electric field is automatically controlled while the electric field is largely reduced. Note that the temperature of the electric furnace may be constant at the occurrence temperature of the flash phenomenon or may further continue increasing. Hereinafter, the case in which the furnace temperature is constant will be described.

Generally, in the flash sintering method, the phenomenon of rapid sintering (sintering in a short period of time) has drawn attention. Therefore, there has not been the above described idea of further keep flowing a constant current to the sample at a constant temperature after the occurrence of the flash phenomenon. On the other hand, in the case in which sintering is carried out in the state in which electrodes such as Pt foil are in direct contact with a ceramic compact as described above, the amount of electric power which can be applied to the sample is limited, and a sintered body having a sufficient density cannot be obtained only by the densification of the flash phenomenon. Therefore, the process of retaining the electricity distribution to the sample after the occurrence of the flash phenomenon is important.

In a case in which a direct-current voltage is applied, the power supply can follow the rapid increase of the current value which occurs in the flash phenomenon, and the control mode can automatically transition from the voltage control mode to the current control mode. On the other hand, in a case in which an alternating-current electric field is applied, since the electric field and the current are oscillating between positive and negative, an ordinary power supply cannot follow this since the increase of the sample current caused along with the flash phenomenon is mixed with the original alternating-current waveforms. Therefore, for example, by making an arrangement described below, a transition from the voltage control mode to the current control mode can be carried out before and after the occurrence of the flash phenomenon.

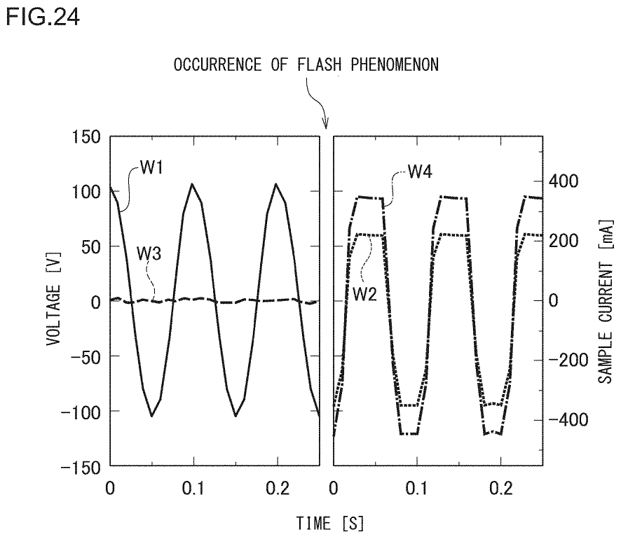

FIG. 24 is a diagram illustrating an example of waveforms of voltages and currents of alternating-current control in a manufacturing method of a sintered body according to a sixth embodiment. The left side of the occurrence of the flash phenomenon of FIG. 24 illustrates the waveforms at the flash temperature or lower, and the right side illustrates the waveforms at the flash temperature or higher. The waveforms W1 and W2 represent voltages, and the waveforms W3 and W4 represent current changes.

As illustrated in FIG. 24, at the flash temperature or lower, the waveform W1 of the voltage forms a sine curve, almost no current flows, and the waveform W3 only slightly vibrates. On the other hand, at the flash temperature or higher, the current value largely increases. In this process, the current value is controlled (waveform W4) so that the part exceeding the limit current value is cut off. In this process, the waveform W2 of the voltage also has a similar waveform as the current value.

As a result, reduction in the resistance value of the sample which occurs in the transition process from the voltage control mode to the current control mode and in the process of the current control mode can be managed, automatic transition from the voltage control mode to the current control mode is enabled, and automatic control with the limit current value set in advance is enabled. Herein, the maximum value of the positive part and the maximum value of the negative part of the waveform W4 of the current are preferred to be approximately the same. If there is a gap between the positive and negative maximum values, since direct-current components are superimposed on alternating-current components, influence of the ion stream unbalance which occurs when a direct-current electric field may appear, and the electrodes may melt. Therefore, the waveform W2 of the voltage after the flash phenomenon occurrence is preferred to have absolute values of both positive and negative voltage amplitude which are smaller than the waveform W1 of the voltage before the flash phenomenon occurrence.

In this manner, as a method of controlling the alternating-current electric field, for example, the power supply 30 is provided with a detector which detects an overload current, and, if the detector detects the limit current value flowing to the ceramic compact, the voltage control mode of the power supply 30 is transitioned to the current control mode so that the current does not exceed the limit current value.

Also, as another method of controlling the alternating-current electric field, a current flowing to the sample may be read by a high-speed current meter and utilized. In this process, peak current values (maximum current values) corresponding to several wavelengths are detected. When the flash phenomenon occurs, this value largely increases. Therefore, this current value is read by an arithmetic device such as a computer, and the stabilizing power supply may be controlled by using the signal line S5 so that a current value set in advance is obtained. In this case, control can be carried out also with sine curves. Also, a standard resistance may be input to the later-described signal line S3 (see FIG. 6), the voltage at both ends thereof may be read by a computer, peak voltage values corresponding to several wavelengths may be read, and a maximum voltage value may be calculated from the values to control the voltage of the stabilizing power supply by the signal line S5 by using the arithmetic device.

As described above, a manufacturing method of a sintered body according to the sixth embodiment is a manufacturing method of the sintered body which increases a temperature while applying an alternating-current electric field to a ceramic compact having a predetermined shape. As illustrated in FIG. 24, the manufacturing method includes: a first process of carrying out temperature increase while applying a first alternating-current electric field (waveform W1) to the ceramic compact up to a flash sintering temperature at which a current flowing to the ceramic compact rapidly increases; and a second process of carrying out temperature increase while applying a second alternating-current electric field (waveform W2) smaller than the first alternating-current electric field after the current flowing to the ceramic compact has rapidly increased and achieved the limit current value illustrated in FIG. 23.

By virtue of this, as illustrated in FIG. 21, the sintered body having a high density which is difficult to be realized only by the conventional flash sintering method in which a direct-current electric field is applied to a sample, can be manufactured with comparatively low electric power.

Also, as illustrated in FIG. 23, in Mode 1, application of the first alternating-current electric field (waveform W1) is executed in the voltage control mode; and, in Mode 2, application of the second alternating-current electric field (waveform W2) is executed in the current control mode. As a result, after the flash phenomenon occurs, current control can be carried out so that the current value does not exceed the predetermined current value as illustrated in FIG. 24. Therefore, occurrence of melting of the electrodes caused by application of excessive electric power to the sample can be reduced. In other words, since higher electric power can be applied to the sample of the ceramic compact, a further-densified high-density sintered body can be manufactured.

Also, the first alternating-current electric field (waveform W1 of FIG. 24) and the second alternating-current electric field (waveform W2 of FIG. 24) are preferred to have a frequency of 10 Hz or higher according to the results illustrated in FIG. 20. By virtue of this, the density of the sintered body can be further improved.

By virtue of this, in the manufacturing method according to the sixth embodiment, the sintered body which has a high density, which is difficult to be realized only by the conventional flash sintering method, can be manufactured in a comparatively short period of time.

### Manufacturing Apparatus

A manufacturing apparatus suitable for the manufacturing method of the sintered body according to the sixth embodiment is the same as the manufacturing apparatus 10 of FIG. 6, and descriptions of the rough configuration thereof is omitted.

The manufacturing apparatus 10 according to the sixth embodiment is provided with the heater 12a which heats the sample 18 of a ceramic compact having a predetermined shape; the pair of electrodes 22 for applying a voltage to the sample 18 of the ceramic compact; the power supply 30 which applies a voltage to the pair of electrodes 22; and the first arithmetic device 28 and the second arithmetic device 32 which control the power supply 30 while increasing the temperature of the ceramic compact by the heater 12a. The first arithmetic device 28 and the second arithmetic device 32 subjects the power supply 30 to voltage control until the current flowing to the ceramic compact rapidly increases and, after the current flowing to the ceramic compact rapidly increases and achieves a predetermined current value, subjects the power supply 30 to current control.

By virtue of this, even with comparatively low electric power which does not melt the electrodes 22, the sintered body having a high density which is difficult to be realized only by the conventional flash sintering method can be manufactured.

Hereinabove, the present disclosure has been described on the basis of the embodiments. These embodiments are examples, and it is understood by those skilled in the art that various modifications can be made for the combinations of constituent elements and processes thereof and that those modifications are also within the scope of the present disclosure.

### INDUSTRIAL APPLICABILITY

The manufacturing methods of the sintered bodies of the present disclosure can be utilized in manufacturing of various high-temperature ceramic members, room-temperature structure ceramics, a core tube of an electric furnace or the like, kitchen knives, tools, industrial polishing/grinding materials, dental ceramic materials, artificial bones, solid electrolyte film materials utilizing electric conductivity, and sensor ceramic materials.

### REFERENCE SIGNS LIST

10 manufacturing apparatus, 12 electric furnace, 12a heater, 14 apparatus main body, 16 control system, 18 sample, 20 sample stage, 22 electrode, 24 rod, 26 detector, 28 first arithmetic device, 30 power supply, 32 second arithmetic device

1. A manufacturing method of a sintered body of increasing a temperature while applying an electric field to a ceramic compact, the manufacturing method comprising
controlling a current flowing to the ceramic compact so that a sintering rate becomes constant.

2. The manufacturing method of the sintered body according to claim 1, wherein in at least a predetermined period of time after the current flowing to the ceramic compact has achieved a predetermined current value, the current flowing to the ceramic compact is controlled so that a sintering rate becomes constant.

3. A manufacturing method of a sintered body of increasing a temperature while applying an electric field to a ceramic compact, the manufacturing method comprising
controlling a current flowing to the ceramic compact by a current profile determined so as to manufacture a ceramic sintered body having a density larger than a predetermined value.

4. A manufacturing method of a sintered body comprising:
a first process of, in a case that temperature increase is carried out while an electric field is applied to a ceramic compact, carrying out the temperature increase while applying a first electric field to the ceramic compact up to a flash sintering temperature at which a current flowing to the ceramic compact rapidly increases; and
a second process of carrying out temperature increase while applying a second electric field smaller than the first electric field after the current flowing to the ceramic compact has rapidly increased and achieved a predetermined current value.

5. A manufacturing method of a sintered body comprising:
a process of increasing a temperature of a ceramic compact to a temperature at which sintering starts;
a process of lowering the temperature of the temperature-increased ceramic compact to a temperature equal to or lower than a predetermined temperature; and
a process of increasing the temperature of the temperature-lowered ceramic compact while applying a predetermined electric field.

6. The manufacturing method of the sintered body according to claim 5, wherein the temperature at which sintering starts is 800 to 1200° C.

7. The manufacturing method of the sintered body according to claim 5, wherein the predetermined temperature is a flash sintering temperature at which a current flowing to the ceramic compact rapidly increases when the temperature of the ceramic compact is increased while the electric field is applied to the ceramic compact.

8. A manufacturing method of a sintered body comprising:
a temperature increasing process of increasing a temperature of a ceramic compact to a predetermined temperature;
an application process of applying a predetermined electric field to the ceramic compact until the temperature achieves the predetermined temperature;
a first current control process of controlling a current flowing to the ceramic compact so that a sintering rate becomes constant after the current flowing to the ceramic compact achieves a first current value in the process of applying the electric field; and
a second current control process of increasing the current flowing to the ceramic compact to a second current value higher than the first current value after the first current control process is executed for a predetermined period of time.

9. The manufacturing method of the sintered body according to claim 1, wherein raw powder of the ceramic compact includes zirconium oxide as a main component.

10. A manufacturing apparatus of a sintered body comprising:
a heater structured to heat a ceramic compact;
an electrode structured to apply a voltage to the ceramic compact;
a voltage applier structured to apply the voltage to the electrode so that a predetermined current flows to the ceramic compact;
a storage structured to store a current profile determined so as to manufacture a ceramic sintered body having a density higher than a predetermined value; and
a controller structured to control the voltage applier on the basis of the current profile while subjecting the ceramic compact to temperature increase by the heater.

11. The manufacturing method of the sintered body according to claim 4, wherein
the first electric field applied to the ceramic compact is a first alternating-current electric field, and
the second electric field applied to the ceramic compact is a second alternating-current electric field.

12. The manufacturing method of the sintered body according to claim 11, wherein
application of the first alternating-current electric field is executed in a voltage control mode in the first process, and
application of the second alternating-current electric field is executed in a current control mode in the second process.

13. The manufacturing method of the sintered body according to claim 12, wherein, when a fact that the current flowing to the ceramic compact has achieved the predetermined current value is detected, a transition from the voltage control mode to the current control mode is carried out so that the current does not exceed the predetermined current value.

14. The manufacturing method of the sintered body according to claim 11, wherein the first alternating-current electric field and the second alternating-current electric field have a frequency of 10 Hz or higher.

15. The manufacturing method of the sintered body according to claim 11, wherein
the ceramic compact has a predetermined shape provided between a pair of electrodes, and
the predetermined shape of the ceramic compact is a cuboid or a columnar shape.

16. The manufacturing method of the sintered body according to claim 11, wherein raw powder of the ceramic compact includes zirconium oxide as a main component.

17. A manufacturing apparatus of a sintered body comprising:
a heater structured to heat a ceramic compact having a predetermined shape;
a pair of electrodes structured to apply a voltage to the ceramic compact;
a voltage applier structured to apply the voltage to the pair of electrodes; and
a controller structured to control the voltage applier while increasing a temperature of the ceramic compact by the heater, wherein
the controller subj ects the voltage applier to voltage control until a current flowing to the ceramic compact rapidly increases and, after the current flowing to the ceramic compact rapidly increases and achieves a predetermined current value, subj ects the voltage applier to current control.

18. The manufacturing apparatus of the sintered body according to claim 17, wherein the controller detects the current flowing to the ceramic compact, and, when the predetermined current value is detected, transitions a voltage control mode of the voltage applier to a current control mode so that the current does not exceed the predetermined current value.

19. The manufacturing method of the sintered body according to claim 6, wherein the predetermined temperature is a flash sintering temperature at which a current flowing to the ceramic compact rapidly increases when the temperature of the ceramic compact is increased while the electric field is applied to the ceramic compact.
